(19) United States
(12) Patent Application Publication
(10) Pub. No.: US 2026/0316052 A1
(43) Pub. Date: Oct. 15, 2026

(54) METHOD FOR RECOVERING NOBLE METAL AND METHOD FOR PRODUCING ADSORBENT TO WHICH NOBLE METAL IS ADSORBED

(71) Applicant: DIC Corporation, Tokyo (JP)

(72) Inventors: Taku Ibaraki, Chiba (JP); Mai Ikeda, Chiba (JP); Takashi Furusawa, Chiba (JP)

(73) Assignee: DIC Corporation, Tokyo (JP)

(21) Appl. No.: 19/677,324

(22) Filed: May 14, 2026

Related U.S. Application Data
(63) Continuation of application No. PCT/JP2024/028558, filed on Aug. 8, 2024.

(30) Foreign Application Priority Data
Dec. 27, 2023 (JP) 2023-221016

(51) Int. Cl. B01J 20/26; B01D 15/08; B01J 20/28; C01G 55/00; C22B 3/00; C22B 3/24

(52) U.S. Cl. CPC B01J 20/262; B01D 15/08; B01J 20/28004; B01J 20/28016; C01G 55/005; C22B 3/24; C22B 13/04

(57) ABSTRACT

A method for recovering a noble metal that enables recovering a noble metal with high selectivity from a liquid containing a noble metal and a base metal is provided. The method recovers a noble metal from a liquid containing the noble metal and a base metal with an adsorbent. The method includes preparing a liquid to be treated that contains the liquid containing the noble metal and the base metal and that has a pH of 4 or less at 23° C., and contacting the liquid to be treated with the adsorbent. The adsorbent contains particles of a polyarylene sulfide resin.

### TECHNICAL FIELD

One or more embodiments of the present invention relate to a method for recovering a noble metal and a method for producing an adsorbent to which a noble metal is adsorbed.

### BACKGROUND

Plastics are used in a wide range of fields from the viewpoint of advantages such as processability and weight reduction. On the other hand, such plastics also have aspects in which various physical properties, such as chemical resistance, weather resistance, wear resistance, and rigidity, are inferior to those of metals. In view of these circumstances, techniques for plating the surface of plastics are known.

As one method for plating non-conductive materials such as plastics, an electroless plating method is known. In this electroless plating method, noble metals such as palladium are widely used as catalysts. However, such noble metals face rising prices, particularly in recent years, as well as large price fluctuations. Therefore, there is a demand for recycling and recovering noble metals contained in plating wastewater.

For recycling and recovering noble metals contained in plating wastewater, various methods such as a precipitation method and an extraction method may be used. In particular, when concentration of noble metals in the wastewater is low, an adsorption method is widely used from the viewpoint of recovery efficiency.

Examples of adsorbents used when recycling and recovering noble metals by an adsorption method include activated carbon, ion-exchange resins, chelate resins. Specifically, for example, Patent Literature 1 discloses a method for recovering a noble metal from a recovery liquid of a noble metal catalyst containing Sn by activated-carbon adsorption. Further, for example, Patent Literature 2 discloses that a solution containing palladium and platinum is brought into contact with an iminodiacetic acid-type chelate resin to adsorb palladium and platinum in the solution onto the iminodiacetic acid-type chelate resin.

### PATENT LITERATURE

PTL 1: JP2019-023356A
PTL 2: JP2015-183228A

Here, as described above, in an electroless plating method using palladium as a catalyst, in many cases, a palladium-tin colloidal catalyst is actually used. In this case, plating wastewater may contain a large amount of tin and a small amount of palladium. Therefore, it is desired that palladium, which is a noble metal, can be selectively recovered from plating wastewater in contrast to tin, which is a base metal.

In this regard, since the above-described activated carbon physically adsorbs a substance to be adsorbed in pores, the adsorption amount is large, however, there is a difficulty in terms of selectively recovering a target metal. In addition, in order to take out the metal recovered by activated carbon, it is necessary to calcine the activated carbon after adsorption. Therefore, there is also a difficulty in terms of environmental burden.

Further, it is considered that the above-described ion-exchange resins and chelate resins can adsorb a target metal selectively to some extent by ion exchange or a chelate effect of functional groups imparted to polymer chains. However, the selectivity is not sufficient.

Accordingly, one or more embodiments of the present invention provide a method for recovering a noble metal that enables recovering a noble metal with high selectivity from a liquid containing a noble metal and a base metal. Further, one or more embodiments of the present invention provide a method for producing an adsorbent to which a noble metal is adsorbed, which can also be obtained by the above-described method for recovering a noble metal.

### SUMMARY

As a result of intensive studies, the inventors have found that adjusting a liquid containing a noble metal and a base metal as specified, and using a certain adsorbent are effective in addressing the above. That is, the gist of one or more embodiments of the present invention is as follows.
[1] A method for recovering a noble metal from a liquid containing a noble metal and a base metal using an adsorbent, in which particles of a polyarylene sulfide resin are used as the adsorbent, including:
a preparation step of preparing a liquid to be treated containing which contains the liquid and has a pH of 4 or less at 23° C.; and
a contacting step of bringing the liquid to be treated into contact with the adsorbent.
[2] The method according to the item [1], in which the noble metal includes palladium.
[3] The method according to the item [1] or [2], in which the liquid to be treated has a concentration of an anion selected from chloride ions, nitrate ions, and sulfate ions of 0.05 mol/L or more.
[4] The method according to the item [3], in which the liquid to be treated has a chloride ion concentration of 0.05 mol/L or more.
[5] The method according to any of the items [1] to [4], in which the concentration of the noble metal in the liquid to be treated is 0.1 to 100 ppm.
[6] The method according to any of the items [1] to [5], in which the concentration of the base metal in the liquid to be treated is 10 to 5000 ppm.
[7] The method according to the item [3], in which the liquid to be treated has a concentration of the anion of 0.1 mol/L or more.
[8] The method according to any of the items [1] to [7], in which the polyarylene sulfide resin has a zeta potential of −50 mV or more as measured by a streaming potential method under conditions of pH 7.8 to 8.2.
[9] The method according to any of the items [1] to [8], in which the particles of the polyarylene sulfide resin have an average particle diameter of more than 10 μm.
[10] The method according to any of the items [1] to [9], in which the contacting step is carried out in the absence of a surfactant.
[11] The method according to any of the items [1] to [10], in which the contacting step is carried out by supplying the liquid to be treated to the immobilized adsorbent.
[12] A method for producing an adsorbent to which a noble metal is adsorbed, in which particles of polyarylene sulfide resin are used as the adsorbent, including:
a preparing step of a liquid to be treated which contains a noble metal and has a pH of 4 or less at 23° C.; and
a contacting step of bringing the liquid to be treated into contact with the adsorbent.
[13] The method according to the item [12], in which the noble metal includes palladium.
[14] The method according to the item [12] or [13], in which the liquid to be treated has a concentration of an anion selected from chloride ions, nitrate ions, and sulfate ions of 0.05 mol/L or more.
[15] The method according to the item [14], in which the liquid to be treated has a chloride ion concentration of 0.05 mol/L or more.
[16] The method according to any of the items [12] to [15], in which the polyarylene sulfide resin has a zeta potential of −50 mV or more as measured by a streaming potential method under conditions of pH 7.8 to 8.2.
[17] The method according to any of the items [12] to [16], in which the particles of the polyarylene sulfide resin have an average particle diameter of more than 10 μm.
[18] The method according to any of the items [12] to [17], in which the adsorbent to which the noble metal is adsorbed is such that 1 to 100 mg of the noble metal is adsorbed per 1 g of the polyarylene sulfide resin.

According to one or more embodiments of the present invention, it is possible to provide a method for recovering a noble metal that enables recovering a noble metal with high selectivity from a liquid containing a noble metal and a base metal.

Further, according to one or more embodiments of the present invention, it is possible to provide a method for producing an adsorbent to which a noble metal is adsorbed.

### DETAILED DESCRIPTION

Hereinafter, one or more embodiments of the present invention (hereinafter, also referred to as “the present embodiment”) will be explained in detail; however, one or more embodiments of the present invention are not limited to the following description, and various modifications can be made and implemented within the scope of the gist thereof.

### (Method for Recovering Noble Metal)

The method for recovering a noble metal of the present embodiment (hereinafter, also simply referred to as a “recovery method”) is a method for recovering a noble metal from a liquid containing a noble metal and a base metal using an adsorbent, and particles of a polyarylene sulfide resin (hereinafter, also referred to as a “PAS resin”) (hereinafter, also referred to as “PAS particles”) are used as the adsorbent. Further, the recovery method of the present embodiment also includes a preparation step of preparing a liquid to be treated which contains the liquid and has a pH of 4 or less at 23° C., and a contacting step of bringing the liquid to be treated into contact with the adsorbent.

The above-described liquid to be treated (that is, the liquid to be treated having a pH of 4 or less) is generally obtained by adjusting the pH by adding an acid. In this case, a certain amount of anions is present in the liquid to be treated due to acid dissociation. Further, as the pH of the liquid to be treated is adjusted to a lower value, the amount of anions in the liquid to be treated increases. In such a liquid to be treated, anions (ligands) bind to metals to form complexes.

Under such circumstances, it is presumed, based on intensive experiments and the like conducted by the present inventors, that the base metal is not adsorbed and only the noble metal is very selectively adsorbed, for reasons such as the following: the base metal has a stronger coordination ability with respect to anions compared to the noble metal and forms a stable complex, therefore it is not adsorbed with weak coordination ability; and sulfur sandwiched between benzene rings in the PAS resin has reduced coordination ability compared with ordinary sulfur due to the influence of π-conjugation of the benzene rings.

Further, when the complexed noble metal and base metal are adsorbed onto the PAS resin, ligand exchange with sulfur(S) present in molecules of the PAS resin is carried out. At this time, there is affinity, what is called the HSAB principle, between the noble metal and base metal and sulfur, and such compatibility affects the ligand exchange. In the HSAB principle, noble metals are classified as soft acids, and base metals are classified as relatively hard acids. On the other hand, sulfur is classified as a soft base and has good affinity with noble metals. Therefore, under conditions of an anion complex, a coordination bond with sulfur is more likely to occur for a noble metal than for a base metal. Together with this, it is presumed that extremely high selectivity for a noble metal is exhibited.

It is considered that these tendencies are involved in combination, and when a liquid to be treated having a pH adjusted as specified is brought into contact with a PAS resin as an adsorbent, the PAS resin selectively adsorbs a noble metal while suppressing an adsorption amount of a base metal. Further, it is suggested that such selective adsorbability of a noble metal may also be attributable to unique crystallinity and/or a molecular structure of the PAS resin.

From the above, according to the recovery method of the present embodiment, it is possible to recover a noble metal with high selectivity from a liquid containing a noble metal and a base metal.

In the present description, the term “metal” in noble metal, base metal and the like includes not only metals themselves but also metal compounds. That is, in the present description, metals such as noble metals and base metals may be in the form of metals themselves, may be in the form of metal compounds, or may be in both forms.

The recovery method of the present embodiment can be suitably employed, for example, when recovering a noble metal from plating wastewater generated in an electroless plating method (generally, such wastewater may contain a noble metal typified by palladium (Pd) and a base metal typified by tin (Sn)).

Hereinafter, materials and the like used in the recovery method of the present embodiment will be explained.

### <Liquid Containing Noble Metal and Base Metal>

In the recovery method of the present embodiment, a liquid containing a noble metal and a base metal (hereinafter, also referred to as a “liquid to be recovered”) is used as a target liquid from which a noble metal is to be recovered. Such a liquid to be recovered is assumed to be plating wastewater generated in an electroless plating method, but is not limited to plating wastewater.

Examples of the liquid constituting the liquid to be recovered include an aqueous liquid, and the liquid may contain an organic substance. Further, the liquid to be recovered may contain a weak acid such as acetic acid, formic acid, carbonic acid, oxalic acid, and phosphoric acid, and may contain a strong acid such as hydrochloric acid, sulfuric acid, and nitric acid.

Examples of the noble metal include gold (Au), silver (Ag), ruthenium (Ru), rhodium (Rh), palladium (Pd), osmium (Os), iridium (Ir), and platinum (Pt). The noble metal may be used alone or in a combination of two or more.

The noble metal contained in the liquid to be recovered may include palladium (Pd). Palladium has relatively good affinity with the adsorbent (PAS resin) in terms of adsorbability also considering ion size, and therefore, when the noble metal includes palladium, the noble metal can be adsorbed onto the PAS particles with higher selectivity.

The concentration of the noble metal in the liquid to be recovered can be, for example, about 0.1 to 100 ppm.

Examples of the base metal include metals other than noble metals. More specifically, examples of the base metal include tin (Sn), cobalt (Co), nickel (Ni), zinc (Zn), iron (Fe), copper (Cu), and chromium (Cr). The base metal may be used alone or in a combination of two or more. In particular, the liquid to be recovered may contain tin (Sn) as the base metal, such as in plating wastewater.

The concentration of the base metal in the liquid to be recovered can be, for example, about 10 to 5000 ppm.

The liquid to be recovered may contain other components in addition to the noble metal and the base metal.

### <Adsorbent (PAS Particles)>

In the recovery method of the present embodiment, particles of a polyarylene sulfide resin (PAS resin) (PAS particles) are used as an adsorbent. It is to be noted that the PAS particles mean particles substantially composed of a polyarylene sulfide resin, or particulate polyarylene sulfide resin.

The PAS resin constituting the PAS particles has a resin structure having, as a repeating unit, a structure in which an aromatic ring and a sulfur atom are bonded to each other. Specifically, the PAS resin has a resin structure having, as repeating units, a structural moiety represented by the following formula (1):

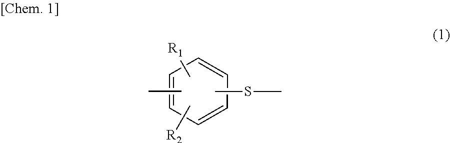

(in which R¹ and R² each independently represent a hydrogen atom, an alkyl group having 1 to 4 carbon atoms, a nitro group, an amino group, a phenyl group, a methoxy group, or an ethoxy group),
and a trifunctional structural moiety represented by the following formula (2):

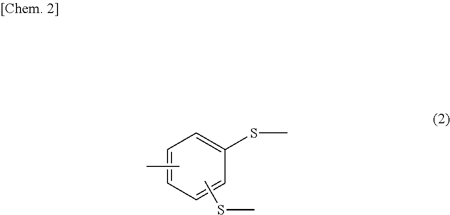

These structural units may be periodically repeated or may be randomly repeated.

The proportion of the trifunctional structural moiety represented by formula (2) relative to the total number of moles of the other structural moieties may be 0.001 mol % or more, or 0.01 mol % or more, and may be 3 mol % or less, or 1 mol % or less.

In the structural moiety represented by formula (1), from the viewpoint of mechanical strength of the PAS resin, both R¹ and R² may be hydrogen atoms. Further, specific examples of the structural moiety represented by formula (1) include a structural moiety bonded at the para position as represented by the following formula (3), a structural moiety bonded at the meta position as represented by the following formula (4), and a structural moiety bonded at the ortho position.

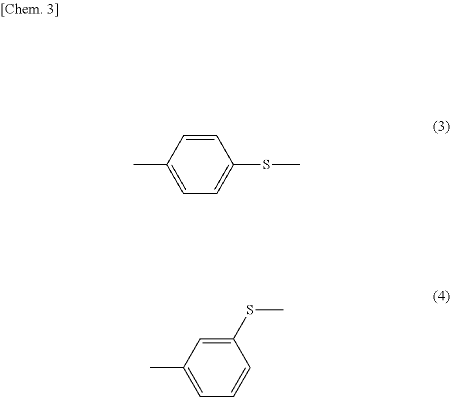

It is preferable that, in the structural moiety represented by formula (1) in the resin structure of the PAS resin, the total proportion of the structural moiety bonded at the meta position and the structural moiety bonded at the ortho position is 1 to 50 mol % of the whole, and the rest is the structural moiety bonded at the para position. In this case, adsorbability can be further improved. Further, it is preferable that, in the resin structure of the PAS resin, the structural moiety represented by formula (1) is composed only of the structural moiety bonded at the para position. In this case, the PAS resin is substantially a polyphenylene sulfide resin (PPS resin), and such a resin is preferable in terms of heat resistance and crystallinity and can be used under a wide range of temperature and pH conditions.

Further, in addition to the structural moiety represented by formula (1) and the structural moiety represented by formula (2), the PAS resin may have at least one of the structural units represented by the following formulae (5) to (8):

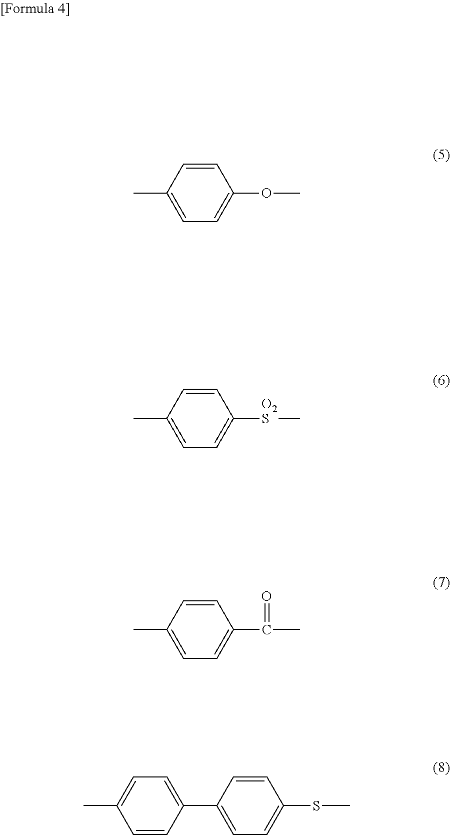

In this case, the proportion of the structural units represented by formulae (5) to (8) can be 30 mol % or less relative to the total number of moles of the structural moiety represented by formula (1) and the structural moiety represented by formula (2). In particular, in the present embodiment, from the viewpoint of heat resistance and mechanical strength of the PAS resin, the proportion of the structural units represented by formulae (5) to (8) may be 10 mol % or less relative to the total number of moles of the structural moiety represented by formula (1) and the structural moiety represented by formula (2). It is to be noted that, when the PAS resin has the structural units represented by formulae (5) to (8), these bonding modes may be random copolymerization or block copolymerization.

Further, the PAS resin may have, in its molecular structure, a naphthyl sulfide bond or the like. However, in this case, the proportion of the above bond relative to the total number of moles of the other structural moieties may be 3 mol % or less, or 1 mol % or less.

The PAS particles can be produced, for example, by synthesizing a PAS resin by polymerization and then performing post-treatment.

The method for synthesizing the PAS resin is not particularly limited, and examples thereof include a method in which a dihalogeno aromatic compound is added in the presence of sulfur and sodium carbonate, and, if necessary, a polyhalogeno aromatic compound and other copolymerization components are further added, followed by polymerization (Synthesis Method 1). Further, examples of the method for synthesizing the PAS resin include a method in which a dihalogeno aromatic compound is added in a polar solvent in the presence of a sulfiding agent or the like, and, if necessary, a polyhalogeno aromatic compound or other copolymerization components are further added, followed by polymerization (Synthesis Method 2). Further, examples of the method for synthesizing the PAS resin include a method in which p-chlorothiophenol is subjected to self-condensation while, if necessary, other copolymerization components are added (Synthesis Method 3). Among these, Synthesis Method 2 is versatile and preferable.

Examples of the dihalogeno aromatic compound include p-dihalobenzene, m-dihalobenzene, o-dihalobenzene, 2,5-dihalotoluene, 1,4-dihalonaphthalene, 1-methoxy-2,5-dihalobenzene, 4,4′-dihalobiphenyl, 3,5-dihalobenzoic acid, 2′ 4-dihalobenzoic acid, 2,5-dihalonitrobenzene, 2,4-dihalonitrobenzene, 2,4-dihaloanisole, p′ p′-dihalodiphenyl ether, 4,4′-dihalobenzophenone, 4,4′-dihalodiphenyl sulfone, 4,4′-dihalodiphenyl sulfoxide, and 4,4′-dihalodiphenyl sulfide, and compounds having, as a ring substituent, an alkyl group having 1 to 18 carbon atoms on an aromatic ring of each of the above compounds.

Examples of the polyhalogeno aromatic compound include 1,2,3-trihalobenzene, 1,2,4-trihalobenzene, 1,3,5-trihalobenzene, 1,2,3,5-tetrahalobenzene, 1,2,4,5-tetrahalobenzene, and 1,4,6-trihalonaphthalene.

The halogen atoms contained in each of the above compounds may be chlorine atoms or bromine atoms.

Examples of the post-treatment method after synthesizing the PAS resin by polymerization include a method of washing by-products contained in the polymerization reaction product (inevitable components derived from the polymerization reaction for PAS resin synthesis) after synthesizing the PAS resin by polymerization. As an example thereof, after completion of the polymerization reaction, the reaction mixture is desolvated to obtain a slurry containing a crude PAS resin; then, the slurry is brought into contact with water and an oxygen atom-containing solvent having 1 to 3 carbon atoms, thereby forming the crude PAS resin into porous particles (PAS particles), then, the obtained PAS particles are washed with carbonated water and filtered; and, if necessary, a dispersion medium is added to obtain a dispersion. In the above post-treatment, a method in which the PAS particles are finally dried into a powder can also be employed, however, it is preferable, from the viewpoint of excellent performance at the start of use, that the PAS particles are not dried and are kept in a state in which the surface of the PAS particles remains wet with the liquid used for washing or the dispersion.

Examples of the oxygen atom-containing solvent having 1 to 3 carbon atoms include methanol, ethanol, n-propyl alcohol, isopropyl alcohol, ethylene glycol, propylene glycol, 2-methoxyethanol, and acetone.

In the PAS particles (adsorbent), it is preferable that no other components than the PAS resin are present on the outer surface thereof (excluding, however, inevitable components derived from the polymerization reaction for PAS resin synthesis and water). Examples of such other components include known conventional additives such as surfactants (dispersants), colorants, antistatic agents, antioxidants, heat stabilizers, ultraviolet stabilizers, ultraviolet absorbers, foaming agents, flame retardants, flame retardant aids, rust inhibitors, mold release agents, and coupling agents.

It is to be noted that “no other components are present” means that the proportion of the PAS resin in the PAS particles may be 95 mass % or more, 99 mass % or more, or 99.9 mass % or more, excluding the inevitable components and water, and may be 100 mass %.

In the PAS particles (adsorbent), it is preferable that no other components than the PAS resin are present inside the PAS particles (excluding, however, inevitable components derived from the polymerization reaction for PAS resin synthesis and water). Examples of such other components include known conventional additives such as surfactants (dispersants), colorants, antistatic agents, antioxidants, heat stabilizers, ultraviolet stabilizers, ultraviolet absorbers, foaming agents, flame retardants, flame retardant aids, rust inhibitors, mold release agents, and coupling agents.

It is to be noted that “no other components are present” means that the proportion of the PAS resin in the PAS particles may be 95 mass % or more, 99 mass % or more, or 99.9 mass % or more, excluding the inevitable components and water, and may be 100 mass %.

It is to be noted that the inevitable components derived from the polymerization reaction for PAS resin synthesis include unreacted raw materials and by-products used in the polymerization reaction, particularly metal atom-containing components among them, such as sulfiding agents (alkali metal sulfides or alkali metal hydrosulfides), alkali metal halides, and a carboxyalkylamino group-containing compound typified by the following formula (9):

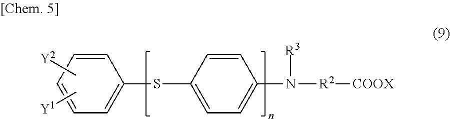

(in which n is 0 to 2, Y¹ represents a halogen atom, Y² represents a hydrogen atom or a halogen atom, R³ represents a hydrogen atom, an alkyl group having 1 to 3 carbon atoms, or a cyclohexyl group, R⁴ represents an alkylene group having 3 to 5 carbon atoms, and X represents an alkali metal atom).

The PAS resin constituting the PAS particles is not particularly limited; however, the zeta potential measured by a streaming potential method under conditions of pH 7.8 to 8.2 may be −50 mV or more, or −30 mV or more.

It is to be noted that the zeta potential of the PAS resin refers to an average value obtained by packing about 100 mg of the PAS resin (in particular, PAS particles) into a cylinder cell and measuring the zeta potential on the resin surface three times using SurPASS 3 (Anton Paar) in an electrolyte solution of a 1 mmol/L aqueous KCl solution at a measurement temperature of 22 to 26° C. Further, in order to stabilize measurement values, it is preferable to sieve the PAS particles and select PAS particles having a particle diameter of 0.05 to 1.0 mm for use.

The specific surface area of the PAS resin constituting the PAS particles is not particularly limited and may be, for example, 1 m²/g or more. In particular, the specific surface area may be 10 m²/g or more. In this case, the PAS particles become porous, and adsorption performance can be further improved. From a similar viewpoint, the specific surface area of the PAS resin may be 50 m²/g or more. On the other hand, the upper limit of the specific surface area of the PAS resin is not particularly limited, however, from the viewpoint of bulk density when filling into a container such as a column, it may be 300 m²/g or less, 250 m²/g or less, or 200 m²/g or less.

It is to be noted that the specific surface area of the PAS resin refers to a BET specific surface area measured after pretreatment for 4 hours under vacuum at 60° C.

The average particle diameter of the PAS particles may be greater than 10 μm. In this case, handling properties and/or liquid feed properties when packed into a column or the like can be further improved. Further, the average particle diameter of the PAS particles may be 2 mm or less from the viewpoint of maintaining favorable adsorption characteristics. From a similar viewpoint, the average particle diameter of the PAS particles may be 20 μm or more, or 30 μm or more, and may be 500 μm or less, or 300 μm or less.

It is to be noted that the average particle diameter of the PAS resin refers to an average particle diameter (D50) determined based on a particle size distribution measured according to a conventional method using a laser diffraction scattering particle size distribution analyzer.

Next, each step in the recovery method of the present embodiment will be explained.

### <Preparation Step>

The preparation step is a step of preparing a liquid to be treated that contains a liquid containing a noble metal and a base metal (liquid to be recovered) and has a pH of 4 or less at 23° C. It is to be noted that, when the pH of the liquid to be recovered is already at or below a predetermined value, the target liquid to be recovered may be used as the liquid to be treated as it is.

On the other hand, when the pH of the liquid to be recovered is higher than a predetermined value, a liquid to be treated can be obtained by adding an acid (or an aqueous solution containing the acid) to the liquid to be recovered and adjusting the pH. Examples of the acid used in this case include strong acids such as hydrochloric acid, sulfuric acid, and nitric acid, as well as weak acids such as acetic acid, formic acid, carbonic acid, oxalic acid, and phosphoric acid. The acid may be used alone or in combination of two or more kinds. Further, the acid may be an inorganic acid or an organic acid. Among these, hydrochloric acid, sulfuric acid, and nitric acid are preferable, and hydrochloric acid is more preferable as the acid to be used. In this case, pH adjustment can be easily performed, and the selectivity of adsorption of the noble metal onto the adsorbent can be effectively enhanced.

The liquid to be treated obtained as described above may have a concentration of anions (excluding hydroxide ions) generated by dissociation of the added acid of 0.05 mol/L or more, or 0.1 mol/L or more. Further, the anions of interest may be anions selected from chloride ions, nitrate ions, and sulfate ions, and among those described above, chloride ions are more preferable. In these cases, the stability of complexes of base metals in the liquid to be treated is further increased, and as a result, base metals become less likely to be adsorbed onto the adsorbent in the subsequent contacting step, thereby further improving the selectivity of adsorption of noble metals onto the adsorbent. On the other hand, the upper limit of the concentration of the anions is not particularly limited; however, from the viewpoint of suppressing an increase in the stability of complexes of noble metals in the liquid to be treated, it may be 5.0 mol/L or less.

It is to be noted that, in the present embodiment, the pH of the liquid to be treated may be 4 or less, or 2 or less. In this case, due to the addition of a larger amount of acid for pH adjustment, the stability of complexes of base metals in the liquid to be treated is further increased, and as a result, base metals become less likely to be adsorbed onto the adsorbent in the subsequent contacting step, thereby further improving the selectivity of adsorption of noble metals onto the adsorbent.

The concentration of noble metals in the liquid to be treated may depend on the concentration of noble metals in the liquid to be recovered, but may be approximately 0.1 to 100 ppm.

The concentration of base metals in the liquid to be treated may depend on the concentration of base metals in the liquid to be recovered, but may be approximately 10 to 5000 ppm.

It is to be noted that, in the recovery method of the present embodiment, noble metals can be recovered with high selectivity even when the concentration of noble metals in the liquid to be treated (and thus in the liquid to be recovered) is sufficiently lower than the concentration of base metals. Specifically, the ratio of the concentration of base metals (ppm) to the concentration of noble metals (ppm) in the liquid to be treated (base metals/noble metals) may be 10 or more, 30 or more, 50 or more, 80 or more, or 100 or more.

### <Contacting Step>

The contacting step is a step of bringing the liquid to be treated prepared in the preparation step into contact with the adsorbent (PAS particles) described above. By this contacting step, noble metals are adsorbed onto the adsorbent with high selectivity. Further, by this contacting step, at least a part of the noble metals is removed from the liquid to be treated.

The method of bringing the liquid to be treated into contact with the adsorbent is not particularly limited, and examples thereof include a method of adding the adsorbent to the liquid to be treated. More specifically, examples include a method of immersing the adsorbent in the liquid to be treated and a method of mixing the liquid to be treated with the adsorbent. At that time, in order to suppress aggregation among particles of the adsorbent (PAS particles), mechanical shear force may be applied, by stirring, vibration, ultrasonic irradiation, or the like.

The amount of the adsorbent used relative to the liquid to be treated is not particularly limited, however, after measuring in advance the concentration of noble metals in the liquid to be treated, the adsorbent (PAS particles) may be used in an amount such that the weight ratio of the adsorbent (PAS particles) to the noble metals is within a range from 1 times or more, 5 times or more, or 10 times or more to 1000 times or less, 500 times or less, or 100 times or less.

Further, the above contacting step may be carried out by supplying the liquid to be treated to the immobilized adsorbent. Specifically, the contacting step may be performed by immobilizing the adsorbent by packing the adsorbent into a container such as a column or supporting the adsorbent on a fiber or a membrane, and supplying the liquid to be treated thereto. Further, the contacting step may be carried out in a batch mode or in a continuous mode. When carried out in a batch mode, examples include a method of supplying the liquid to be treated to a container in which the adsorbent is immobilized. When carried out in a continuous mode, examples include a method in which the adsorbent is immobilized in a flow path and the liquid to be treated is continuously supplied (passed) through the flow path. Any known method may be used for immobilization, as long as the adsorbent is partitioned by a wall having pores of a size that allows the liquid (liquid to be treated) to pass therethrough but prevents the adsorbent (PAS particles) from passing therethrough, thereby enabling separation from the liquid (liquid to be treated). By immobilizing the adsorbent in this manner, a solid-liquid separation step (described later) can be easily carried out.

Further, when the contacting step is carried out in a continuous mode as described above, from the viewpoint of adsorption efficiency of noble metals, the space velocity (SV) in the flow path of the liquid to be treated may be 200 or less, 100 or less, or 20 or less. The lower limit of the space velocity (SV) is not particularly limited, but may be 5 or more. Within these ranges, the efficiency of adsorbing (separating) noble metals from the liquid to be treated by the adsorbent is excellent. It is to be noted that the space velocity (SV) indicates how many times the volume of solution (m³) is passed per hour relative to the volume (m³) of the adsorbent immobilized in the flow path.

The temperature of the contacting step is not particularly limited and may be appropriately selected, for example, it may be 10 to 80° C.

It is to be noted that the contacting step may be carried out in the absence of a surfactant from the viewpoints of exhibiting adsorption characteristics and reducing elution into the liquid to be treated. It is to be noted that “in the absence of a surfactant” means that no surfactant is present in any environment in carrying out the recovery method of the present embodiment, including the adsorbent, the liquid to be treated, and apparatus used for performing each step.

### <Solid-Liquid Separation Step>

In the recovery method of the present embodiment, a step of performing solid-liquid separation may be carried out after the contacting step. The method of solid-liquid separation is not particularly limited, and examples thereof include sedimentation separation, flotation separation, sand filtration, centrifugation, suction filtration, microfiltration, and ultrafiltration. By such solid-liquid separation, the adsorbent onto which noble metals have been adsorbed can be taken out from the liquid.

### <Regeneration Treatment Step>

Further, in the recovery method of the present embodiment, by subjecting the adsorbent taken out in the solid-liquid separation step to a regeneration treatment, noble metals adsorbed on the adsorbent can be recovered. Examples of the regeneration treatment include a method of passing an eluent (for example, an aqueous alkaline solution or an aqueous solution in which a sulfur atom-containing or nitrogen atom-containing chelating agent is dissolved) through the taken-out adsorbent. By passing the eluent in this manner, the adsorbed noble metals can be recovered as a concentrated solution. Further, if necessary, a washing treatment may be carried out in which an acid or alkaline aqueous solution is passed through the adsorbent to remove trace impurities adhering to the adsorbent. Since the regeneration treatment can regenerate the adsorbent simply by passing a liquid suitable for the adsorbed noble metals/base metals, the adsorbent can be reused many times without the need for calcination as required for activated carbon, thereby contributing to reduction of environmental burden. Moreover, the adsorbent after the regeneration treatment can be used again in the recovery method of the present embodiment.

(Method for Producing an Adsorbent to which Noble Metals are Adsorbed)

The method for producing an adsorbent to which noble metals are adsorbed according to the present embodiment (hereinafter also simply referred to as the “producing method”) uses PAS particles are used as the adsorbent. Further, the producing method of the present embodiment includes a preparation step of preparing a liquid to be treated which contains noble metals and has a pH of 4 or less at 23° C., and a contacting step of bringing the liquid to be treated into contact with the adsorbent.

It is to be noted that, except as specifically described below, the materials and the like used in the producing method of the present embodiment and the respective steps thereof are substantially the same as the materials and the like (such as the adsorbent (PAS particles)) and the respective steps (the preparation step, the contacting step, the optional solid-liquid separation step, the optional regeneration treatment step, etc.) in the recovery method of the present embodiment described above. Accordingly, in the present description, the explanation relating to the producing method of the present embodiment applies the explanation relating to the recovery method of the present embodiment described above, except for matters specifically described below.

The producing method of the present embodiment includes a preparation step of preparing a liquid to be treated which contains noble metals and has a pH of 4 or less at 23° C. That is, the producing method of the present embodiment differs from the recovery method of the present embodiment described above in that the liquid to be treated is not required to contain base metals. However, the liquid to be treated prepared in the producing method of the present embodiment may contain base metals, as in the recovery method of the present embodiment. The liquid to be treated containing base metals is the same as that described in the recovery method of the present embodiment.

In the producing method of the present embodiment, an adsorbent to which noble metals are adsorbed (hereinafter also referred to as a “noble metal-adsorbed adsorbent”) is produced by the above contacting step. Such a noble metal-adsorbed adsorbent may be one in which 1 to 100 mg of the noble metal is adsorbed per 1 g of PAS resin. It is to be noted that the amount of noble metals adsorbed per 1 g of PAS resin in the noble metal-adsorbed adsorbent can be controlled, for example, by appropriately adjusting the pH or anion concentration of the liquid to be treated, the contact time between the liquid to be treated and the adsorbent, the concentration of noble metals in the liquid to be treated, and the mass ratio or volume ratio between the liquid to be treated and the adsorbent during contacting.

### Examples

Hereinafter, one or more embodiments of the present invention will be explained in more detail with reference to Examples. However, one or more embodiments of the present invention are not limited in any way to the following Examples.

### <Synthesis of PAS Resin>

Into a 150 L autoclave equipped with a stirring blade and fitted with a pressure gauge, a thermometer, a condenser, a decanter, and a rectifying column, 33.222 kg (226 mol) of p-dichlorobenzene (hereinafter abbreviated as DCB), 2.280 kg (23 mol) of N-methyl-2-pyrrolidone (hereinafter abbreviated as NMP), 27.300 kg (230 mol) of 47.23 mass % sodium hydrosulfide, and 18.533 kg (228 mol) of 49.21 mass % caustic soda were charged. The temperature was then raised to 173° C. over 5 hours under a nitrogen atmosphere with stirring, thereby 27.3 kg of water was distilled off. Thereafter, the autoclave was sealed. DCB distilled off azeotropically during dehydration was separated by the decanter and returned to the autoclave as appropriate. After completion of dehydration, the autoclave was in a state in which an anhydrous sodium sulfide composition was dispersed in DCB. Subsequently, the internal temperature was cooled to 160° C., and 47.492 kg (479 mol) of NMP was charged, followed by heating to 185° C. When the pressure reached 0.00 MPa, the valve connected to the rectifying column was opened, and the temperature was raised to 200° C. over 1 hour. At this time, control was performed by cooling and valve opening so that the outlet temperature of the rectifying column did not exceed 110° C. The mixed vapor of distilled DCB and water was condensed in the condenser, separated by the decanter, and the DCB was returned to the autoclave. The amount of distilled water was 179 g. Next, the temperature was raised from 200° C. to 230° C. over 3 hours, stirred for 1 hour, then raised to 250° C. and stirred for 1 hour. After completion of the reaction, the internal temperature of the autoclave was lowered from 250° C. to 235° C., and upon reaching this temperature, the bottom valve of the autoclave was opened to flash the contents, under reduced pressure, into a 150 L vacuum stirring dryer equipped with a stirring blade (desolvation unit jacket temperature: 120° C.), thereby removing NMP. After cooling to room temperature, sampling revealed that a PAS mixture (PPS mixture) having a nonvolatile content of 55% was obtained.

### <Preparation of PAS Particles (Adsorbent)>

400 g of the PAS mixture obtained by above and 317 g of methanol were placed in a flask, and the mixture was stirred and mixed at 40° C. for 30 minutes to obtain a slurry. The obtained slurry was vacuum-filtered using a Kiriyama funnel, pressed from above, and further 634 g of methanol was poured from above in several portions and filtered. Next, the cake produced by the filtration was transferred to a beaker and crushed into powder with a spatula. Then, 634 g of water at 70° C. was added thereto, and the mixture was stirred and mixed for 30 minutes. The resulting slurry was vacuum-filtered using a Kiriyama funnel, pressed from above, and further 845 g of water at 70° C. was poured from above in several portions and filtered. The cake was transferred to a beaker, and 636 g of carbonated water was added thereto and stirred and mixed for 1 hour. Subsequently, the slurry was vacuum-filtered using a Kiriyama funnel, pressed from above, and further 848 g of carbonated water was poured from above in several portions and filtered to obtain a wet cake (PAS particles). For the obtained PAS particles (PPS particles), the water content calculated from loss on drying was 47.5 mass %. Further, the PAS particles had a zeta potential of −15 mV as measured by the streaming potential method under conditions of pH 7.8 to 8.2, a specific surface area of 119 m²/g, and an average particle diameter (D50) of 30 μm. These PAS particles were used as the adsorbent in the following.

### <Preparation of Liquids to be Treated>

Using “Palladium Standard Solution Pd1000” and “Tin Standard Solution Sn1000” manufactured by Kanto Chemical Co., Inc., a liquid simulating plating wastewater was prepared by adjusting the palladium concentration to 5 mg/L (ppm) and the tin concentration to 250 mg/L (ppm). Thereafter, the solution was diluted and adjusted with an aqueous hydrochloric acid solution and ammonium chloride so that the chloride ion concentration and the pH at 23° C. were as shown in Table 1, thereby preparing liquids to be treated 1 to 3.

TABLE 1

| | Liquid to be | Liquid to be | Liquid to be |
|---|---|---|---|
| | treated 1 | treated 2 | treated 3 |
| Pd concentration [ppm] | 5 | 5 | 5 |
| Sn concentration [ppm] | 250 | 250 | 250 |
| pH | 4.5 | 2 | 1 |
| Chloride ion concentration | 0.01 | 0.1 | 1 |
| [mol/L] | | | |

### <Contact Between Liquid to be Treated and Adsorbent>

Into a 30 mL test tube 5 mL of a liquid to be treated selected from liquids to be treated 1 to 3 and an amount of the adsorbent shown in Table 2 corresponding to 0.025 g in terms of resin content were weighed. Next, using a shaker (“SA300”, manufactured by Yamato Scientific Co., Ltd.), the mixture was shaken and stirred horizontally at a liquid temperature of 30° C. and 200 rpm for 3 hours so that adsorption reached equilibrium. Thereafter, solid-liquid separation was carried out by suction filtration to recover the liquid phase component. Using the concentrations (ppm) of metals (palladium and tin) in the liquid phase component, the adsorption ratio (%) of each metal was calculated according to the following equation. The results are shown in Table 2.

Adsorption ratio (%)={(metal concentration in the liquid to be treated before adsorption −metal concentration in the liquid phase component after adsorption equilibrium)/metal concentration in the liquid to be treated before adsorption}×100

TABLE 2

| | Comparative | Example | Example | Comparative | Comparative | Comparative | Comparative | Comparative | Comparative |
|---|---|---|---|---|---|---|---|---|---|
| | Example 1 | 1 | 2 | Example 2 | Example 3 | Example 4 | Example 5 | Example 6 | Example 7 |
| Adsorbent used | PAS particles | | | Ion-exchange resin *1 | | | Chelate resin *2 | | |
| Liquid to be | 1 | 2 | 3 | 1 | 2 | 3 | 1 | 2 | 3 |
| treated used | | | | | | | | | |
| (see Table 1) | | | | | | | | | |
| Pd adsorption | 96 | 98 | 92 | 98 | 97 | 87 | 81 | 75 | 44 |
| ratio [%] | | | | | | | | | |
| Sn adsorption | 92 | 3 | 2 | 68 | 57 | 83 | 65 | 55 | 31 |
| ratio [%] | | | | | | | | | |

1 Ion-exchange resin: “DIAION (registered trademark) SA10A”, manufactured by Mitsubishi Chemical Corporation, strongly basic anion-exchange resin
2 Chelate resin: “DIAION (registered trademark) CR11”, manufactured by Mitsubishi Chemical Corporation, iminodiacetic acid-type chelate resin

From Tables 1 and 2, it can be seen that, when recovering a noble metal from a liquid containing a noble metal and a base metal, in the Examples in which the pH of the liquid at 23° C. was adjusted to 4 or less and PAS particles were used as the adsorbent, a large amount of the noble metal (palladium) was adsorbed while sufficiently suppressing adsorption of the base metal (tin), as compared with Comparative Examples in which the pH was adjusted to more than 4 and Comparative Examples in which other adsorbents such as an ion-exchange resin or a chelate resin were used. In particular, in the present Examples, although the concentration of the base metal in the liquid to be treated was significantly higher than the concentration of the noble metal, the fact that the noble metal could nevertheless be selectively adsorbed can be regarded as a remarkable effect.

According to one or more embodiments of the present invention, it is possible to provide a method for recovering a noble metal that enables recovering a noble metal with high selectivity from a liquid containing a noble metal and a base metal.

Further, according to one or more embodiments of the present invention, it is possible to provide a method for producing an adsorbent to which a noble metal is adsorbed.

Although the disclosure has been described with respect to only a limited number of embodiments, those skilled in the art, having benefit of this disclosure, will appreciate that various other embodiments may be devised without departing from the scope of the present disclosure. Accordingly, the scope of the invention should be limited only by the attached claims.

1. A method for recovering a noble metal, comprising:
preparing a liquid to be treated comprising a liquid containing the noble metal and a base metal, wherein the liquid to be treated has a pH of 4 or less at 23° C.; and
contacting the liquid to be treated with an adsorbent, thereby recovering the noble metal from the liquid containing the noble metal and the base metal,
wherein the adsorbent comprises particles of a polyarylene sulfide resin.

2. The method according to claim 1, wherein the noble metal includes palladium.

3. The method according to claim 1, wherein the liquid to be treated has a concentration of an anion of 0.05 mol/L or more, wherein the anion is selected from the group consisting of chloride ions, nitrate ions, and sulfate ions.

4. The method according to claim 3, wherein the liquid to be treated has a chloride ion concentration of 0.05 mol/L or more.

5. The method according to claim 1, wherein a concentration of the noble metal in the liquid to be treated is 0.1 to 100 ppm.

6. The method according to claim 1, wherein a concentration of the base metal in the liquid to be treated is 10 to 5000 ppm.

7. The method according to claim 3, wherein the liquid to be treated has the concentration of the anion of 0.1 mol/L or more.

8. The method according to claim 1, wherein the polyarylene sulfide resin has a zeta potential of −50 mV or more as measured by a streaming potential method under conditions of pH in a range of 7.8 to 8.2.

9. The method according to claim 1, wherein the particles of the polyarylene sulfide resin have an average particle diameter of more than 10 μm.

10. The method according to claim 1, wherein the contacting is carried out in absence of a surfactant.

11. The method according to claim 1, wherein the contacting is carried out by supplying the liquid to be treated to an immobilized adsorbent.

12. A method for producing an adsorbent to which a noble metal is adsorbed, comprising:
preparing a liquid to be treated containing the noble metal and having a pH of 4 or less at 23° C.; and
contacting the liquid to be treated with the adsorbent, thereby adsorbing the noble metal to the adsorbent,
wherein the adsorbent comprises particles of a polyarylene sulfide resin.

13. The method according to claim 12, wherein the noble metal includes palladium.

14. The method according to claim 12, wherein the liquid to be treated has a concentration of an anion of 0.05 mol/L or more, and wherein the anion is selected from the group consisting of chloride ions, nitrate ions, and sulfate ions.

15. The method according to claim 14, wherein the liquid to be treated has a chloride ion concentration of 0.05 mol/L or more.

16. The method according to claim 12, wherein the polyarylene sulfide resin has a zeta potential of −50 m V or more as measured by a streaming potential method under conditions of pH in a range of 7.8 to 8.2.

17. The method according to claim 12, wherein the particles of the polyarylene sulfide resin have an average particle diameter of more than 10 μm.

18. The method according to claim 12, wherein the adsorbent to which the noble metal is adsorbed has 1 to 100 mg of the noble metal adsorbed per 1 g of the polyarylene sulfide resin.
